(19) United States
(12) Patent Application Publication
(10) Pub. No.: US 2026/0370174 A1
(43) Pub. Date: Nov. 19, 2026

(54) MOTOR DRIVING DEVICE FOR ESTIMATING TEMPERATURE OF PART

(71) Applicant: FANUC CORPORATION, Yamanashi (JP)

(72) Inventors: Koujirou Sakai, Yamanashi (JP); Masato Wakabayashi, Yamanashi (JP)

(21) Appl. No.: 19/155,122

(22) PCT Filed: Mar. 9, 2023
(86) PCT No.: PCT/JP2023/009116

§ 371 Date: Aug. 8, 2025

(51) Int. Cl. H02P 29/68

(52) U.S. Cl. CPC H02P 29/68

(57) ABSTRACT

A motor driving device that includes a rotational speed command unit that generates a rotational speed command of a fan motor; a fan motor control unit that controls rotation of the fan motor in accordance with the rotational speed command; a storage unit that stores a pair of a thermal resistance and a thermal time constant of a part, the pair corresponding to each piece of information related to a plurality of rotational speeds of the fan motor; a current detection unit that detects a value of a current flowing to the part inside an amplifier; and a temperature estimation unit that calculates an estimated temperature of the part on the basis of any of the plurality of pairs of thermal resistances and thermal time constants that are stored in the storage unit and the value of the current detected by the current detection unit.

### CROSS-REFERENCE TO RELATED APPLICATIONS

This application is a National Stage application of International Application No. PCT/JP2023/009116 filed Mar. 9, 2023.

### BACKGROUND

### Field

The present disclosure relates to a motor drive device for estimating the temperature of a part.

### Discussion of the Related Art

The temperature inside a motor drive device rises due to heat generation in various parts during operation of the motor drive device. Therefore, a cooling fan for cooling heat-generating parts is provided inside the motor drive device. The cooling fan is driven by a fan motor. Since an excessive rise in the internal temperature of the motor drive device causes various failures, overheat protection processing involving temperature estimation with heat-generating parts as temperature estimation target objects is generally performed.

### SUMMARY

In temperature estimation processing based on the premise that the fan motor rotates at a rated rotation speed, an actual temperature may greatly deviate from an estimated temperature depending on the actual operating state of the motor drive device. Accordingly, an accurate estimation of the temperature of a part is desired in a motor drive device including a fan motor.

According to an aspect of the present disclosure, a motor drive device includes a rotation speed command unit configured to generate a rotation speed command for a fan motor driving a cooling fan for cooling a part, a fan motor control unit configured to control rotation of the fan motor in accordance with the rotation speed command generated by the rotation speed command unit, a storage unit configured to store a set of a thermal resistance and a thermal time constant of the part related to each of a plurality of pieces of information relating to a rotation speed of the fan motor, a current detection unit configured to detect a value of current flowing through a part in an amplifier supplying electric power to a machine motor, and a temperature estimation unit configured to calculate an estimated temperature of the part, based on one of a plurality of sets of the thermal resistance and the thermal time constant stored in the storage unit and a value of the current detected by the current detection unit.

### BRIEF DESCRIPTION OF DRAWINGS

FIG. 1 is a block diagram illustrating a motor drive device according to a first embodiment of the present disclosure.

FIG. 2 is a block diagram illustrating a motor drive device according to a second embodiment of the present disclosure.

FIG. 3 is a block diagram illustrating a motor drive device according to a third embodiment of the present disclosure.

FIG. 4 is a flowchart illustrating temperature estimation processing and alarm output processing in the motor drive device according to each embodiment of the present disclosure.

FIG. 5 is a side view schematically illustrating a substrate on which a power semiconductor is mounted.

FIG. 6 is a block diagram illustrating an equation in a first aspect used in temperature estimation of the power semiconductor.

FIG. 7 is a diagram for comparing each embodiment of the present disclosure with a conventional technology with regard to temperature estimation of a part.

FIG. 8 is a flowchart illustrating an operation flow of rotation control of a fan motor based on an amplifier output in the motor drive device according to each embodiment of the present disclosure.

FIG. 9 is a flowchart illustrating an operation flow of rotation control of a fan motor based on the internal temperature of an amplifier in the motor drive device according to each embodiment of the present disclosure.

FIG. 10 is a flowchart illustrating an operation flow of rotation control of a fan motor when a machine motor is stopped in the motor drive device according to each embodiment of the present disclosure.

### DESCRIPTION OF EMBODIMENTS

Motor drive devices according to embodiments estimating the temperature of a part will be described below with reference to the drawings. It should be noted that components having the same or similar functions are given the same sign in the following description. Then, overlapping description of the components may be omitted. For ease of understanding, the drawings use different scales as appropriate. In the following description, a “machine motor” means a motor being a driving source of a machine (e.g., a robot or a machine tool) in which the motor drive device is provided and being a motor driven by the motor drive device. A “fan motor” means a motor driving a cooling fan for cooling parts in the motor drive device.

Examples of heat-generating parts in the motor drive device include a power semiconductor and a preliminary charging resistor. The heat-generating parts such as a power semiconductor and a preliminary charging resistor are assumed to be temperature estimation target objects in each embodiment.

The motor drive device drives a machine motor for operating a machine (e.g., a robot or a machine tool) in which the motor drive device is provided. The motor drive device includes an amplifier for driving the machine motor, based on direct-current voltage supplied from a rectifier. Types of the amplifier include an amplifier including an inverter, an amplifier including a rectifier, and an amplifier including an inverter integrated with a rectifier. The inverter is configured with a full-bridge circuit based on semiconductor switching elements and diodes respectively connected in antiparallel with the semiconductor switching elements. A rectifier based on diode rectification is configured with a diode-based full-bridge circuit. A rectifier with a power regeneration function is configured with a full-bridge circuit based on semiconductor switching elements and diodes respectively connected in antiparallel with the semiconductor switching elements. The semiconductor switching element and the diode handling high voltage and large current and being provided in the inverter and/or the rectifier provided in the motor drive device are referred to as power semiconductors. The power semiconductor may be an intelligent power module (IPM) being a power semiconductor element in which a semiconductor switching element, a drive circuit thereof, and a self-protection function are incorporated. Examples of the semiconductor switching element include an IGBT, an FET, a thyristor, a GTO, and a transistor but may also include another semiconductor element. When a switching operation is performed by the power semiconductor, heat is generated.

A smoothing capacitor is provided between the rectifier and the inverter. The smoothing capacitor is preferably charged to predetermined magnitude of voltage after power to the motor drive device is turned on and before drive of the motor is started (i.e., before a power conversion operation by the inverter starts). The charging is also referred to as “preliminary charging” or “initial charging.” Since preliminary charging is started in a state of energy not being accumulated in the smoothing capacitor, a large rush current flows through the amplifier immediately after power to the motor drive device is turned on. Therefore, a preliminary charging circuit suppressing rush current is generally provided in the amplifier. The preliminary charging circuit may be referred to as an “initial charging circuit” or a “rush current suppression circuit.” The preliminary charging circuit is configured with a preliminary charging resistor suppressing rush current and a switch connected in parallel with the preliminary charging resistor. When current flows through the preliminary charging resistor, heat is generated.

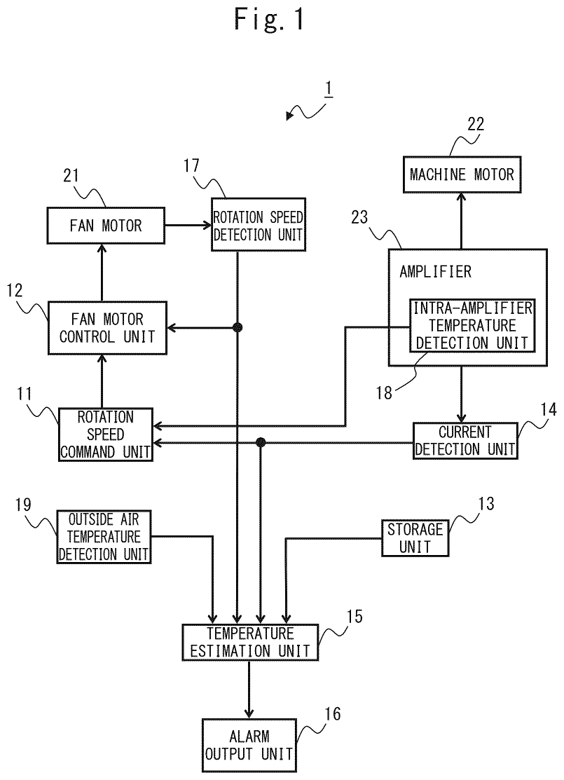

FIG. 1 is a block diagram illustrating a motor drive device according to a first embodiment of the present disclosure.

A motor drive device 1 according to the first embodiment drives a machine motor 22 for operating a machine (e.g., a robot or a machine tool). Alternating-current power for driving the machine motor 22 is supplied by an amplifier 23. The amplifier 23 may be controlled by a higher level controller (e.g., a robot controller or a numeric controller). A case of the amplifier 23 including a rectifier and an inverter will be described below as an example. The inverter includes a power semiconductor configured with a semiconductor switching element and a diode connected in antiparallel with the semiconductor switching element. A rectifier based on diode rectification is configured with a diode-based full-bridge circuit. A rectifier with a power regeneration function is configured with a full-bridge circuit based on semiconductor switching elements and diodes respectively connected in antiparallel with the semiconductor switching elements. Further, a preliminary charging circuit is provided for suppressing rush current flowing through the amplifier immediately after power to the motor drive device is turned on. The preliminary charging circuit includes a preliminary charging resistor and a switch connected in parallel with the preliminary charging resistor. The power semiconductor and the preliminary charging resistor being heat-generating parts are mounted on a heat sink and are cooled by a cooling fan provided close by. The cooling fan is driven by a fan motor 21. The fan motor 21 may be an alternating-current fan motor or a direct-current fan motor.

The motor drive device 1 includes a rotation speed command unit 11, a fan motor control unit 12, a storage unit 13, a current detection unit 14, a temperature estimation unit 15, an alarm output unit 16, a rotation speed detection unit 17, an intra-amplifier temperature detection unit 18, and an outside air temperature detection unit 19.

The current detection unit 14 detects the value of current flowing through a part in the amplifier 23 supplying electric power to the machine motor 22. When a part being a temperature estimation target object of the temperature estimation unit 15 is a power semiconductor, the value of current flowing through the power semiconductor is detected as the value of current flowing through the part detected by the current detection unit 14. When a part being a temperature estimation target object of the temperature estimation unit 15 is a preliminary charging resistor, the value of current flowing through the preliminary charging resistor is detected as the value of current flowing through the part detected by the current detection unit 14. Data related to the value of current flowing through a part detected by the current detection unit 14 are sent to the temperature estimation unit 15. Further, the current detection unit 14 detects the value of input current of the amplifier 23 or the value of output current of the amplifier 23. Data related to the value of input current or the value of output current detected by the current detection unit 14 are sent to the rotation speed command unit 11 and the temperature estimation unit 15.

The intra-amplifier temperature detection unit 18 is a temperature sensor detecting the internal temperature of the amplifier 23 (may be hereinafter referred to as an “intra-amplifier temperature”). For example, the internal temperature of the amplifier 23 is the temperature inside the housing of the amplifier 23. Data related to the internal temperature of the amplifier 23 detected by the intra-amplifier temperature detection unit 18 are sent to the rotation speed command unit 11.

The outside air temperature detection unit 19 is a temperature sensor detecting the outside air temperature outside the amplifier 23. For example, the outside air temperature is the temperature outside the housing of the amplifier 23. Data related to the outside air temperature outside the amplifier 23 detected by the outside air temperature detection unit 19 are sent to the temperature estimation unit 15.

The rotation speed command unit 11 generates a rotation speed command for the fan motor 21 driving the cooling fan.

For example, in a cutting machine, the output of an amplifier during non-cutting, such as a tool change or alignment, is lower than the output of the amplifier during cutting. The internal temperature of the amplifier 23 changes according to the output of the amplifier 23. The internal temperature of the amplifier 23 during operation of a machine (e.g., a robot or a machine tool) at an output lower than normal is lower compared with the internal temperature of the amplifier 23 during operation of the machine at a normal output. Since the internal temperature of the amplifier 23 does not rise so much while the output of the amplifier 23 is low, decreasing the rotation speed of the fan motor 21 driving the cooling fan to below normal does not cause an issue. Then, the rotation speed command unit 11 generates a rotation speed command according to the output of the amplifier 23.

For example, the rotation speed command unit 11 may generate a rotation speed command entailing continuous change, e.g., the rotation speed of the fan motor 21 decreasing with decrease in the output of the amplifier 23.

For example, the rotation speed command unit 11 may generate discrete rotation speed commands and particularly generate a rotation speed command for an energy saving mode for decreasing the rotation speed when the output of the amplifier 23 is less than a predetermined output threshold value and a rotation speed command for a normal mode for increasing the rotation speed when the output of the amplifier 23 is equal to or greater than the predetermined output threshold value. The output threshold value is used for distinguishing between the normal mode and the energy saving mode, based on the output of the amplifier 23, and is set to, for example, a value of about several tens of percent less than the output of the amplifier 23 when the amplifier 23 operates normally. It should be noted that the numerical value given here is strictly an example and another numerical value may be used. Further, a rotation speed command related to an additional mode other than the two modes being the normal mode and the energy saving mode (e.g., a rotation speed command related to each of three or more modes) may be generated as a discrete rotation speed command.

It should be noted that when the value of the input current of the amplifier 23 is detected by the current detection unit 14, the value of the input power acquired by multiplying the value of the input current of the amplifier 23 by the value of the input voltage of the amplifier 23 is used as the output of the amplifier 23. When the value of the output current of the amplifier 23 is detected by the current detection unit 14, the value of the output power acquired by multiplying the value of the output current of the amplifier 23 by the value of the output voltage of the amplifier 23 is used as the output of the amplifier 23. For example, the output of the amplifier 23 is calculated by the rotation speed command unit 11.

The rotation speed command unit 11 may generate a rotation speed command, based on the internal temperature of the amplifier 23 detected by the intra-amplifier temperature detection unit 18. For example, the rotation speed command unit 11 may generate a rotation speed command entailing continuous change, such as the rotation speed of the fan motor 21 decreasing with decrease in the internal temperature of the amplifier 23. Further, for example, the rotation speed command unit 11 may generate discrete rotation speed commands and particularly generate a rotation speed command for the energy saving mode for decreasing the rotation speed when the internal temperature of the amplifier 23 is less than a predetermined internal temperature threshold value and a rotation speed command for the normal mode for increasing the rotation speed when the internal temperature of the amplifier 23 is equal to or greater than the predetermined internal temperature threshold value. Further, a rotation speed command related to an additional temperature other than the two temperature commands for a high temperature and a low temperature (e.g., a rotation speed command related to each of three or more temperatures) may be generated as a discrete rotation speed command.

The rotation speed commands generated by the rotation speed command unit 11 as described above are sent to the fan motor control unit 12.

An encoder (unillustrated) for detecting the rotation speed and the rotation position of the fan motor 21 is attached to the rotation axis of the fan motor 21. The rotation speed detection unit 17 acquires a rotation speed detection value of the fan motor 21 from the encoder. Data related to the rotation speed detection value acquired by the rotation speed detection unit 17 are sent to the fan motor control unit 12 and the temperature estimation unit 15.

The fan motor control unit 12 controls rotation (more specifically, the rotation speed) of the fan motor 21, based on a rotation speed command generated by the rotation speed command unit 11 and a rotation speed detection value acquired by the rotation speed detection unit 17. When the fan motor 21 is configured with an alternating-current fan motor, the fan motor control unit 12 controls rotation of the fan motor 21 by adjusting alternating-current power supplied to the fan motor 21. When the fan motor 21 is configured with a direct-current fan motor, the fan motor control unit 12 controls rotation of the fan motor 21 by adjusting direct-current power supplied to the fan motor 21.

The storage unit 13 stores a plurality of pieces of information relating to the rotation speed of the fan motor 21 in association with sets of a thermal resistance and a thermal time constant of a part being a temperature estimation target object respectively related to the plurality of pieces of information relating to the rotation speed. Information relating to the rotation speed stored in the storage unit 13 is a rotation speed detection value in the first embodiment. A thermal resistance and a thermal time constant that are related to a rotation speed detection value are previously measured by, for example, referring to a specification table of the part (e.g., a power semiconductor or a preliminary charging resistor) being the temperature estimation target object or performing an experiment and are stored into the storage unit 13. For example, in the experiment, work of rotating the fan motor 21 in accordance with a certain rotation speed command and measuring a rotation speed detection value, and a thermal resistance and a thermal time constant at that time is performed a plurality of times. A plurality of rotation speed detection values measured by the experiment are stored into the storage unit 13 in association with sets of a thermal resistance and a thermal time constant respectively related to the rotation speed detection values.

Data including rotation speed detection values and sets of a thermal resistance and a thermal time constant may be discrete or continuous.

For example, when data including rotation speed detection values and sets of a thermal resistance and a thermal time constant are prepared as discrete data, a rotation speed detection value, and a thermal resistance and a thermal time constant when the fan motor 21 is rotated in accordance with a rotation speed command for the normal mode and a rotation speed detection value, and a thermal resistance and thermal time constant when the fan motor 21 is rotated in accordance with a rotation speed command for the energy saving mode are measured experimentally, and the measurement result is stored into the storage unit 13. When an additional mode other than the two modes being the normal mode and the energy saving mode is provided, a rotation speed detection value, and a thermal resistance and a thermal time constant when the fan motor 21 is rotated in accordance with a rotation speed command related to the mode are measured, and the measurement result is stored into the storage unit 13.

For example, when data including rotation speed detection values and sets of a thermal resistance and a thermal time constant are prepared as continuous data, work of measuring a rotation speed detection value, and a thermal resistance and a thermal time constant when the fan motor 21 is rotated in accordance with a certain rotation speed command is performed a plurality of times, a table indicating a relation between a rotation speed detection value and a set of a thermal resistance and a thermal time constant in ranges from a low rotation speed range to a high rotation speed range is found by applying an approximation method, such as the least squares method, to data including the acquired rotation speed detection values and the acquired sets of a thermal resistance and a thermal time constant, and the table is stored into the storage unit 13.

A set of a thermal resistance and a thermal time constant related to the rotation speed detection value acquired by the rotation speed detection unit 17 out of the plurality of sets of a thermal resistance and a thermal time constant stored in the storage unit 13 is read by the temperature estimation unit 15.

For example, data including rotation speed detection values and sets of a thermal resistance and a thermal time constant are prepared as discrete data, the temperature estimation unit 15 determines whether the normal mode or the energy saving mode is used by using the rotation speed threshold value, based on a rotation speed detection value acquired by the rotation speed detection unit 17, and, based on the determination result, reads a set of a thermal resistance and a thermal time constant related to the mode from the storage unit 13. For example, the rotation speed threshold value is set to a value of about several tens of percent less than the rated speed of the fan motor 21. It should be noted that the numerical value given here is strictly an example and another numerical value may be used.

For example, when data including rotation speed detection values and sets of a thermal resistance and a thermal time constant are prepared as continuous data, the temperature estimation unit 15 reads a set of a thermal resistance and a thermal time constant related to a rotation speed detection value acquired by the rotation speed detection unit 17 from the storage unit 13.

The temperature estimation unit 15 calculates an estimated temperature of a part being a temperature estimation target object, based on a set of a thermal resistance and a thermal time constant related to a rotation speed detection value acquired by the rotation speed detection unit 17 out of a plurality of sets of a thermal resistance and a thermal time constant stored in the storage unit 13, the value of current detected by the current detection unit 14, and an outside air temperature detected by the outside air temperature detection unit 19. An equation related to a part being a temperature estimation target object, and a thermal resistance and a thermal time constant are used in temperature estimation processing by the temperature estimation unit 15. Accordingly, the temperature estimation processing by the temperature estimation unit 15 is performed for each type of part. In other words, the temperature estimation unit 15 independently performs the temperature estimation processing on the power semiconductor and the temperature estimation processing on the preliminary charging resistor. Examples of an equation used in the temperature estimation processing by the temperature estimation unit 15 will be described later. Data related to the estimated temperature calculated by the temperature estimation unit 15 are sent to the alarm output unit 16.

The alarm output unit 16 compares an estimated temperature calculated by the temperature estimation unit 15 with a temperature threshold value. When the estimated temperature calculated by the temperature estimation unit 15 is greater than the temperature threshold value, the alarm output unit 16 outputs an alarm. When the estimated temperature calculated by the temperature estimation unit 15 is equal to or less than the temperature threshold value, the alarm output unit 16 does not output an alarm. As the temperature threshold value, a temperature threshold value related to a part being a temperature estimation target object is used. When the temperature estimation target object is a power semiconductor, for example, the temperature threshold value is set to a value of about several to several tens of percent less than a heat-resistant temperature described in a specification table of the power semiconductor. When the temperature estimation target object is a preliminary charging resistor, for example, the temperature threshold value is set to a value of about several to several tens of percent less than a heat-resistant temperature described in a specification table of the preliminary charging resistor. It should be noted that the numerical value given here is strictly an example, and another numerical value may be used.

For example, when an alarm is output from the alarm output unit 16, “the temperature zone estimation target object being abnormal due to overheat” may be displayed on a display device (unillustrated) by using characters or a picture. Further, the value of an estimated temperature itself calculated by the temperature estimation unit 15 may be displayed on the display device regardless of existence of output of an alarm from the alarm output unit 16. Examples of the display device include a standalone display device, a display device attached to the motor drive device 1, a display device attached to a higher level controller (e.g., a robot controller or a numeric controller) connected to the motor drive device 1, and display devices attached to a personal computer and a mobile terminal.

For example, when an alarm is output from the alarm output unit 16, “the temperature zone estimation target object being abnormal due to overheat” may be notified by an audio device (unillustrated) producing a sound, such as a voice, a speaker, a buzzer, or a chime. For example, the audio device may be silent when the temperature zone estimation target object is not abnormal due to overheat and may produce a sound when the temperature zone estimation target object is abnormal due to overheat.

For example, when an alarm is output from the alarm output unit 16, “the temperature zone estimation target object being abnormal due to overheat” may be notified by print out on paper or the like by using a printer (unillustrated).

The aforementioned operation examples when an alarm is output from the alarm output unit 16 may be provided in combination as appropriate. Alarms may be utilized in failure prediction and preventive maintenance by being stored, accumulated, and databased in a storage device (unillustrated) every time an alarm is output from the alarm output unit 16.

Furthermore, the operation of the motor drive device 1 may be urgently stopped every time an alarm is output from the alarm output unit 16. An operator can recognize “occurrence of some abnormality in the motor drive device 1” also by an emergency stop of the operation of the motor drive device 1.

When an alarm is output from the alarm output unit 16, an operator can promptly and reliably recognize an abnormality of a part due to overheat. Therefore, when an abnormality of a part due to overheat is confirmed, the operator can perform maintenance work such as replacement or repair of the part.

At least one processor being an arithmetic processing unit is provided in the motor drive device 1. Examples of the arithmetic processing unit include an IC, an LSI, a CPU, an MPU, and a DSP. The arithmetic processing unit includes the rotation speed command unit 11, the fan motor control unit 12, the temperature estimation unit 15, the alarm output unit 16, the rotation speed detection unit 17, a control unit (unillustrated) in the amplifier 23, and other processing units. For example, each unit included in the arithmetic processing unit is a function module provided by a program executed on the processor. For example, when the rotation speed command unit 11, the fan motor control unit 12, the temperature estimation unit 15, the alarm output unit 16, the rotation speed detection unit 17, the control unit in the amplifier 23, and the other processing units are constructed in a form of a program, the function of each unit can be provided by operating the arithmetic processing unit in accordance with the program. The program for executing each type of processing in the rotation speed command unit 11, the fan motor control unit 12, the temperature estimation unit 15, the alarm output unit 16, the rotation speed detection unit 17, the control unit in the amplifier 23, and the other processing units may be provided in a form of being recorded on a computer-readable recording medium, such as a semiconductor memory; a magnetic recording medium; or an optical recording medium. Alternatively, the rotation speed command unit 11, the fan motor control unit 12, the temperature estimation unit 15, the alarm output unit 16, the rotation speed detection unit 17, the control unit in the amplifier 23, and the other processing units may be provided as a semiconductor integrated circuit into which a program providing the function of each unit is written.

Further, at least one memory being a storage device is provided in the motor drive device 1. The memory includes the storage unit 13. Examples of the memory include an electrically erasable/recordable nonvolatile memory, such as an EEPROM (registered trademark); and random-access memories capable of high-speed read/write, such as a DRAM and an SRAM. For example, the storage device may have a configuration such as an HDD or an SSD. A program for operating the rotation speed command unit 11, the fan motor control unit 12, the temperature estimation unit 15, the alarm output unit 16, the rotation speed detection unit 17, the control unit in the amplifier 23, and the other processing units may be stored in the memory. Further, data related to an estimated temperature of a part calculated by the temperature estimation unit 15 may be stored in the memory. Further, a history of alarms output by the alarm output unit 16 may be stored in the memory. Further, various types of data related to the motor drive device 1 may be stored in the memory.

According to the first embodiment, the temperature estimation processing is performed by using a thermal resistance and a thermal time constant based on the rotation speed of the fan motor 21 driving the cooling fan cooling a part, and therefore, an estimated temperature of the part is calculated with high precision. For example, when the rotation speed of the fan motor 21 decreases due to a cause such as degradation of a bearing, adherence of a coolant or dust, or decrease in electric power supplied to the fan motor 21, the temperature of a part rises. According to the first embodiment, an estimated temperature of the part can be calculated with high precision by using a thermal resistance and a thermal time constant based on the rotation speed detection value of the fan motor 21. Further, according to the first embodiment, control is performed in such a way that the rotation speed of the fan motor 21 is decreased as the output of the amplifier 23 decreases, and therefore, the part is not excessively cooled, which saves energy. Further, control is performed in such a way that the rotation speed of the fan motor 21 is decreased as the internal temperature of the amplifier 23 decreases, and therefore, the part is not excessively cooled, which saves energy.

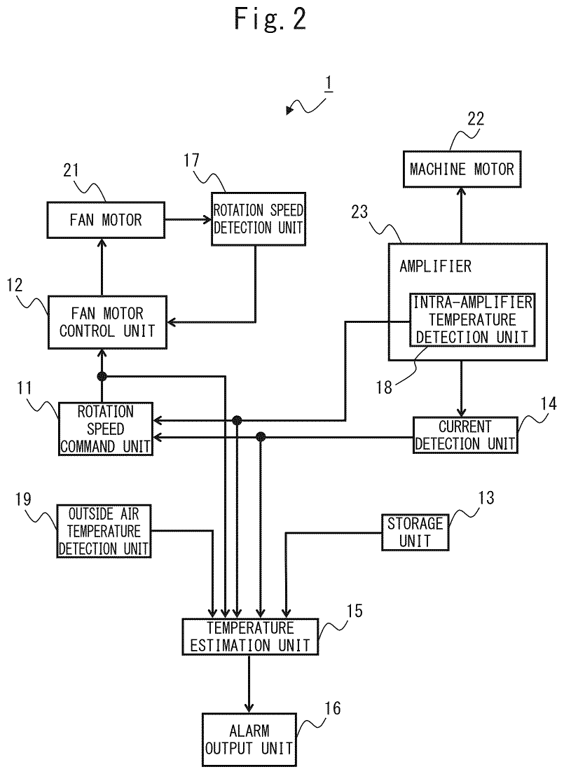

FIG. 2 is a block diagram illustrating a motor drive device according to a second embodiment of the present disclosure.

Information relating to a rotation speed stored in a storage unit 13 is a rotation speed command in the second embodiment. A temperature estimation unit 15 estimates the temperature of a part by using a set of a thermal resistance and a thermal time constant related to each rotation speed command.

A motor drive device 1 according to the second embodiment includes a rotation speed command unit 11, a fan motor control unit 12, the storage unit 13, a current detection unit 14, the temperature estimation unit 15, an alarm output unit 16, a rotation speed detection unit 17, an intra-amplifier temperature detection unit 18, and an outside air temperature detection unit 19.

Descriptions of a fan motor 21, a machine motor 22, an amplifier 23, the rotation speed command unit 11, the fan motor control unit 12, the current detection unit 14, the alarm output unit 16, the rotation speed detection unit 17, the intra-amplifier temperature detection unit 18, the outside air temperature detection unit 19, a power semiconductor, a preliminary charging resistor, a display device, audio equipment, and a printer are as described in the first embodiment with reference to FIG. 1.

The storage unit 13 according to the second embodiment stores a plurality of rotation speed commands for the fan motor 21 in association with “sets of a thermal resistance and a thermal time constant of a part” respectively related to the plurality of rotation speed commands for the fan motor 21. A thermal resistance and a thermal time constant that are related to a rotation speed command are previously measured by, for example, referring to a specification table of a part (e.g., a power semiconductor or a preliminary charging resistor) being a temperature estimation target object or performing an experiment, and the measurement result is stored into the storage unit 13. For example, in the experiment, work of rotating the fan motor 21 in accordance with a certain rotation speed command and measuring a thermal resistance and a thermal time constant at that time is performed a plurality of times. A plurality of experimentally measured rotation speed commands and sets of a thermal resistance and a thermal time constant respectively related to the rotation speed commands are stored into the storage unit 13.

Data including rotation speed commands and sets of a thermal resistance and a thermal time constant may be discrete or continuous.

For example, when data including rotation speed commands and sets of a thermal resistance and a thermal time constant are prepared as discrete data, a thermal resistance and a thermal time constant when the fan motor 21 is rotated in accordance with a rotation speed command for a normal mode and a thermal resistance and a thermal time constant when the fan motor 21 is rotated in accordance with a rotation speed command for an energy saving mode are measured experimentally, and the measurement result is stored into the storage unit 13. When an additional mode other than the two modes being the normal mode and the energy saving mode is provided, a thermal resistance and a thermal time constant when the fan motor 21 is rotated in accordance with a rotation speed command related to the mode may be measured.

For example, when data including rotation speed commands and sets of a thermal resistance and a thermal time constant are prepared as continuous data, work of measuring a thermal resistance and a thermal time constant when the fan motor 21 is rotated in accordance with a certain rotation speed command is performed a plurality of times, a table indicating a relation between a rotation speed command and a set of a thermal resistance and a thermal time constant in ranges from a low rotation speed range to a high rotation speed range is found by applying an approximation method, such as the least squares method, to data including the acquired rotation speed commands and the acquired sets of a thermal resistance and a thermal time constant, and the table is stored into the storage unit 13.

A set of a thermal resistance and a thermal time constant related to a rotation speed command generated by the rotation speed command unit 11 out of a plurality of sets of a thermal resistance and a thermal time constant stored in the storage unit 13 is read by the temperature estimation unit 15.

For example, when data including rotation speed commands and sets of a thermal resistance and a thermal time constant are prepared as discrete data, the temperature estimation unit 15 determines whether the normal mode or the energy saving mode is used, based on a rotation speed command generated by the rotation speed command unit 11, and, based on the determination result, reads a set of a thermal resistance and a thermal time constant related to the mode from the storage unit 13. For example, a rotation speed command for rotating the fan motor 21 at a rated speed is a rotation speed command for the normal mode, and a rotation speed command for rotating the fan motor 21 at a rotation speed less than the rated speed is a rotation speed command for the energy saving mode.

For example, data including rotation speed commands and sets of a thermal resistance and a thermal time constant are prepared as continuous data, the temperature estimation unit 15 reads a set of a thermal resistance and a thermal time constant related to a rotation speed command generated by the rotation speed command unit 11 from the storage unit 13.

The temperature estimation unit 15 calculates an estimated temperature of a part, based on a set of a thermal resistance and a thermal time constant related to a rotation speed command generated by the rotation speed command unit 11 out of a plurality of sets of a thermal resistance and a thermal time constant stored in the storage unit 13, the value of current detected by the current detection unit 14, and an outside air temperature detected by the outside air temperature detection unit 19. The temperature estimation unit 15 independently performs temperature estimation processing on the power semiconductor and the temperature estimation processing on the preliminary charging resistor. Examples of an equation used in the temperature estimation processing by the temperature estimation unit 15 will be described later. Data related to an estimated temperature calculated by the temperature estimation unit 15 are sent to the alarm output unit 16.

The second embodiment can provide effects similar to the effects provided by the first embodiment described above.

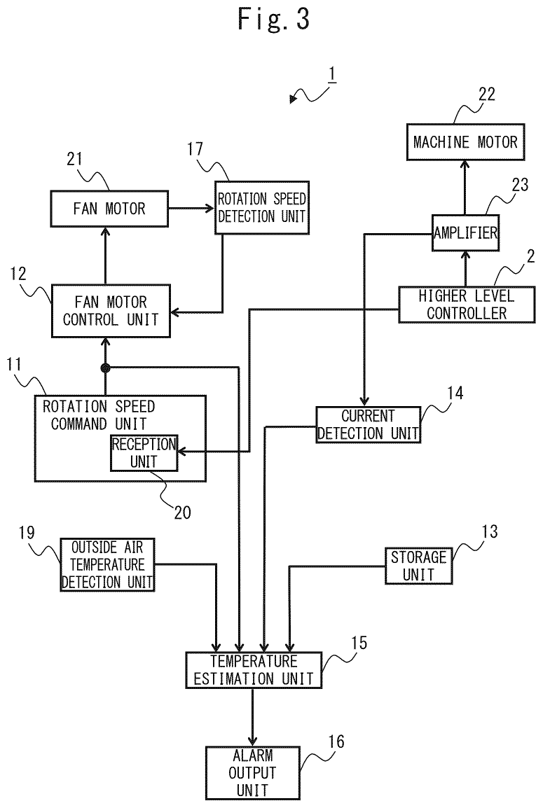

FIG. 3 is a block diagram illustrating a motor drive device according to a third embodiment of the present disclosure.

Information relating to a rotation speed stored in a storage unit 13 is a rotation speed command in the third embodiment. A temperature estimation unit 15 estimates the temperature of a part by using a set of a thermal resistance and a thermal time constant related to each rotation speed command for a fan motor 21 received from a higher level controller 2 (e.g., a robot controller or a numeric controller) controlling the operation of a motor drive device 1.

The motor drive device 1 according to the third embodiment includes a rotation speed command unit 11, a fan motor control unit 12, the storage unit 13, a current detection unit 14, the temperature estimation unit 15, an alarm output unit 16, a rotation speed detection unit 17, and an outside air temperature detection unit 19.

Descriptions of the fan motor 21, a machine motor 22, an amplifier 23, the fan motor control unit 12, the current detection unit 14, the alarm output unit 16, the rotation speed detection unit 17, the outside air temperature detection unit 19, a power semiconductor, a preliminary charging resistor, a display device, audio equipment, and a printer are as described in the first embodiment with reference to FIG. 1.

The storage unit 13 according to the third embodiment stores a plurality of rotation speed commands for the fan motor 21 in association with “sets of a thermal resistance and a thermal time constant of a part” respectively related to the plurality of rotation speed commands for the fan motor 21. Storage of rotation speed commands and sets of a thermal resistance and a thermal time constant of a part by the storage unit 13 is as described in the first embodiment with reference to FIG. 1.

The higher level controller 2 controls the amplifier 23 by operating in accordance with an operation program of the machine motor 22. Examples of the higher level controller 2 include a robot controller and a numeric controller. For example, vibrations caused by rotation of the fan motor 21 may affect machine accuracy in a robot or a machine tool. Then, the higher level controller 2 generates a rotation speed command for the fan motor 21 with reference to the operation program of the machine motor in such a way that vibrations caused by rotation of the fan motor 21 does not affect machine accuracy and sends the generated rotation speed command to the rotation speed command unit 11. When the operation program of the machine motor 22 indicates that “the output of the amplifier 23 is low,” the higher level controller 2 generates a rotation speed command for an energy saving mode setting the rotation speed of the fan motor 21 to a predetermined value or less and sends the generated rotation speed command to the rotation speed command unit 11. When receiving a stop command, the higher level controller 2 generates a rotation speed command for stopping setting the rotation speed of the fan motor 21 to a predetermined value or less (e.g., a rotation speed zero) and sends the generated rotation speed command to the rotation speed command unit 11. Examples of the stop command received by the higher level controller 2 include a normal stop command issued by an operation by an operator and an emergency stop command based on detection of an abnormality in a machine (a robot or a machine tool).

The rotation speed command unit 11 includes a reception unit 20 configured to receive a rotation speed command for the fan motor 21 from the higher level controller 2. The rotation speed command unit 11 transfers the rotation speed command received by the reception unit 20 to the fan motor control unit 12.

The temperature estimation unit 15 calculates an estimated temperature of a part, based on a set of a thermal resistance and a thermal time constant related to a rotation speed command from the higher level controller 2 out of a plurality of sets of a thermal resistance and a thermal time constant stored in the storage unit 13, the value of current detected by the current detection unit 14, and an outside air temperature detected by the outside air temperature detection unit 19.

The third embodiment can provide effects similar to the effects provided by the first and second embodiments described above. Further, temperature estimation of a part based on a rotation speed command from the higher level controller 2 can be performed.

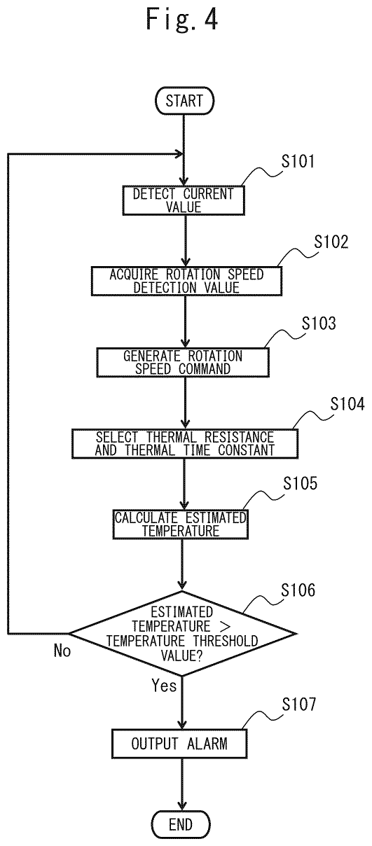

FIG. 4 is a flowchart illustrating the temperature estimation processing and alarm output processing in the motor drive device according to each embodiment of the present disclosure.

A plurality of pieces of information relating to the rotation speed of the fan motor 21 are stored into the storage unit 13 in association with sets of a thermal resistance and a thermal time constant respectively related to the plurality of pieces of information relating to the rotation speed before step S101 is executed. Information relating to the rotation speed stored in the storage unit 13 is a rotation speed detection value in the first embodiment. Information relating to the rotation speed stored in the storage unit 13 is a rotation speed command in the second and third embodiments.

In step S101, the current detection unit 14 detects the value of current flowing through a part in the amplifier 23. Data related to the value of the current flowing through the part detected by the current detection unit 14 are sent to the temperature estimation unit 15. Further, the current detection unit 14 detects the value of the input current of the amplifier 23 or the value of the output current of the amplifier 23. Data related to the value of the input current or the value of the output current detected by the current detection unit 14 are sent to the rotation speed command unit 11 and the temperature estimation unit 15.

In step S102, the rotation speed detection unit 17 acquires a rotation speed detection value of the fan motor 21 from the encoder. Data related to the rotation speed detection value acquired by the rotation speed detection unit 17 are sent to the fan motor control unit 12 and the temperature estimation unit 15.

In step S103, the rotation speed command unit 11 generates a rotation speed command for the fan motor 21. Thus, the fan motor control unit 12 controls rotation of the fan motor 21, based on the rotation speed command generated by the rotation speed command unit 11 and the rotation speed detection value acquired by the rotation speed detection unit 17.

In step S104, the temperature estimation unit 15 selects one of the plurality of sets of a thermal resistance and a thermal time constant stored in the storage unit 13 and reads the set from the storage unit 13. A set of a thermal resistance and a thermal time constant related to the rotation speed detection value acquired by the rotation speed detection unit 17 is selected in the first embodiment. A set of a thermal resistance and a thermal time constant related to the rotation speed command generated by the rotation speed command unit 11 is selected in the second embodiment. A set of a thermal resistance and a thermal time constant related to a rotation speed command received from the higher level controller 2 by the reception unit 20 is selected in the third embodiment.

In step S105, the temperature estimation unit 15 calculates an estimated temperature of the part, based on the set of a thermal resistance and a thermal time constant selected in step S104, the value of the current flowing through the part detected by the current detection unit 14, and an outside air temperature detected by the outside air temperature detection unit 19.

In step S106, the alarm output unit 16 compares the estimated temperature calculated by the temperature estimation unit 15 with a temperature threshold value and determines whether the estimated temperature is greater than the temperature threshold value.

When the estimated temperature is determined to be greater than the temperature threshold value in step S106, the alarm output unit 16 outputs an alarm in step S107.

When the estimated temperature is not determined to be greater than the temperature threshold value in step S106 (i.e., when the estimated temperature is equal to or less than the temperature threshold value), the processing returns to step S101.

An equation related to a part being a temperature estimation target object (e.g., a power semiconductor or a preliminary charging resistor), and a thermal resistance and a thermal time constant are used in the temperature estimation processing by the temperature estimation unit 15. Accordingly, the processing in S104 to S107 is performed for each type of part. In other words, the processing in S104 to S107 related to a power semiconductor is performed independently of the processing in S104 to S107 related to a preliminary charging resistor.

Several aspects of equations used in the temperature estimation processing on a power semiconductor by the temperature estimation unit 15 will be enumerated.

First, an equation in a first aspect used in temperature estimation of a power semiconductor element will be described.

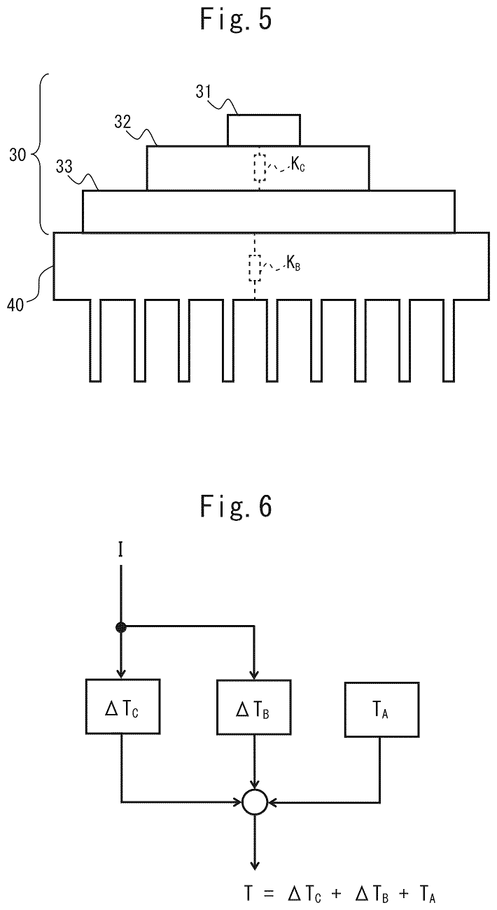

FIG. 5 is a side view schematically illustrating a substrate on which a power semiconductor is mounted.

A power semiconductor 30 includes a base substrate 33, an insulating substrate 32 provided on the top surface of the base substrate 33, and a semiconductor chip 31 provided on the top surface of the insulating substrate 32. The power semiconductor 30 is provided on the top surface of a radiator 40. The radiator 40 is configured in such a way that as many faces as possible are exposed to the outside air.

FIG. 6 is a block diagram illustrating an equation in the first aspect used in temperature estimation of the power semiconductor.

The temperature T [°C] of the power semiconductor can be estimated from a thermal resistance KC [°C/A] and a thermal time constant τ_{C} [sec] between the semiconductor chip 31 and the base substrate, a thermal resistance K_{B} [°C/A] and a thermal time constant K_{B} [sec] between the outside air temperature and the base substrate, the outside air temperature TA [°C], and the amplitude I [A] of three-phase current flowing through the power semiconductor 30.

The temperature rise ΔT_{C} [°C] between the semiconductor chip 31 and the base substrate when three-phase current with an amplitude I [A] flows through the power semiconductor 30 can be expressed as Equation 1.

$$Δ {T}_{C} = {K}_{C} \cdot I \{ 1 - exp ( - \frac{t}{{τ}_{C}} ) \} \qquad ( 1 )$$

The temperature rise ΔT_{B} [°C] between the outside air temperature and the base substrate when three-phase current with the amplitude I [A] flows through the power semiconductor 30 can be expressed as Equation 2.

$$Δ {T}_{B} = {K}_{B} \cdot I \{ 1 - exp ( - \frac{t}{{τ}_{B}} ) \} \qquad ( 2 )$$

The temperature T [°C] of the power semiconductor when three-phase current with the amplitude I [A] flows through the power semiconductor 30 can be expressed as Equation 3 by using the temperature rise ΔT_{C} [°C] in Equation 1, the temperature rise ΔT_{B} [°C] in Equation 2, and the outside air temperature TA [C].

T=ΔT_{C}+ΔTK_{B}+T_{A} (3)

For example, the temperature estimation unit 15 calculates an estimated temperature of the power semiconductor 30 in accordance with the equations in the first aspect represented by Equation 1 to Equation 3.

Next, an equation in a second aspect used in temperature estimation of the power semiconductor element will be described.

Denoting the loss in the power semiconductor when three-phase current with the amplitude I [A] flows through the power semiconductor by P1(s), the thermal resistance of the power semiconductor by KD [°C/A], the thermal time constant of the power semiconductor by TD [sec], and the outside air temperature by TA [°C], the temperature T [°C] of the power semiconductor when three-phase current with the amplitude I [A] flows through the power semiconductor can be found by using a transfer function represented by Equation 4. It should be noted that “s” in Equation 4 denotes a parameter in the frequency domain in a Laplace transform.

$$T = \frac{{K}_{D}}{{τ}_{D} s + 1} {P}_{1} ( s ) + {T}_{A} \qquad ( 4 )$$

For example, the temperature estimation unit 15 calculates an estimated temperature of the power semiconductor 30 in accordance with the equation in the second aspect represented by Equation 4.

Several aspects of equations used in the temperature estimation processing on a power semiconductor by the temperature estimation unit 15 will be enumerated.

First, an equation in the first aspect used in temperature estimation of a preliminary charging resistor will be described.

The temperature T [°C] of the power semiconductor can be estimated in accordance with Equation 5, based on the thermal resistance KE [°C/A] and the thermal time constant τ_{E} [sec] of the preliminary charging resistor, the outside air temperature TA [°C], and the amplitude I [A] of current flowing through the preliminary charging resistor.

$$T = {T}_{A} + {K}_{e} \cdot {I}^{2} \{ 1 - exp ( - \frac{t}{{τ}_{E}} ) \} \qquad ( 5 )$$

For example, the temperature estimation unit 15 calculates an estimated temperature of the preliminary charging resistor in accordance with the equation in the first aspect represented by Equation 5.

Next, an equation in the second aspect used in temperature estimation of the preliminary charging resistor will be described.

Denoting the loss in the preliminary charging resistor when current with the amplitude I [A] flows through the preliminary charging resistor by P2(s), the thermal resistance of the preliminary charging resistor by KF [°C/A], the thermal time constant of the preliminary charging resistor by τ_{F} [sec], and the outside air temperature by T_{A} [°C], the temperature T [°C] of the preliminary charging resistor when current with the amplitude I [A] flows through the preliminary charging resistor can be found by using a transfer function represented by Equation 6. It should be noted that “s” in Equation 6 denotes a parameter in the frequency domain in a Laplace transform.

$$T = \frac{{K}_{F}}{{τ}_{F} s + 1} {P}_{2} ( s ) + {T}_{A} \qquad ( 6 )$$

For example, the temperature estimation unit 15 calculates an estimated temperature of the power semiconductor 30 in accordance with the equation in the second aspect represented by Equation 6.

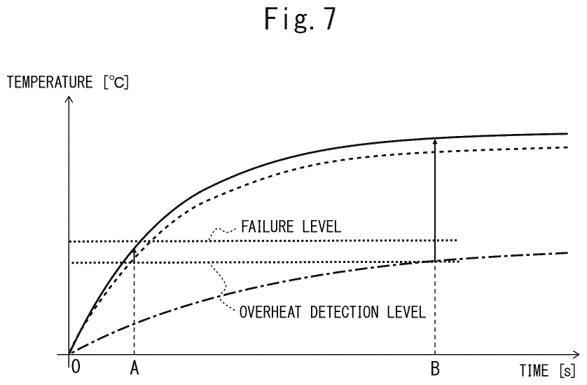

FIG. 7 is a diagram for comparing each embodiment of the present disclosure with a conventional technology with regard to temperature estimation of a part.

FIG. 7 illustrates temperature changes of a part when current starts to flow through the amplifier 23 at a time 0 [sec] and the fan motor rotates at a rotation speed less than a rated rotation speed. A thick solid line in FIG. 7 indicates an actual temperature [°C] of the part being a temperature estimation target object. A thick broken line in FIG. 7 indicates an estimated temperature [°C] of the part calculated by the temperature estimation unit 15 according to each embodiment of the present disclosure. A thick dot-and-dash line in FIG. 7 indicates an estimated temperature [°C] of the part calculated on the assumption that the fan motor rotates at the rated rotation speed in a conventional technology.

The thermal resistance and the thermal time constant change according to the rotation speed (in other words, the airflow volume) of the fan motor driving the cooling fan cooling the radiator. The thermal resistance and the thermal time constant increase as the rotation speed of the fan motor decreases. The temperature of the part increases as the thermal resistance increases. The time required for the temperature of the part to change increases as the thermal time constant increases.

As indicated by the thick dot-and-dash line in FIG. 7, according to the conventional technology, the estimated temperature of the part is calculated without consideration of the actual rotation speed in spite of the fact that the fan motor rotates at a rotation speed lower than the rated rotation speed and therefore greatly deviates from the actual temperature of the part indicated by the thick solid line in FIG. 7. While the estimated temperature of the part reaches an overheat detection level at a time B [sec] according to the conventional technology, a failure level of the part is already exceeded at that point in time. Accordingly, the conventional technology cannot provide overheat protection due to a failure of the part.

As indicated by the thick broken line in FIG. 7, the estimated temperature of the part is calculated based on information relating to the rotation speed of the fan motor 21 (a rotation speed detection value or a rotation speed command) according to each embodiment of the present disclosure, and therefore, the estimated temperature is close to the actual temperature. The estimated temperature of the part reaches the overheat detection level at a time A [sec] but does not reach the failure level of the part at that point in time. Accordingly, each embodiment of the present disclosure enables detection of an abnormality due to overheat before a failure of the part and therefore enables overheat protection.

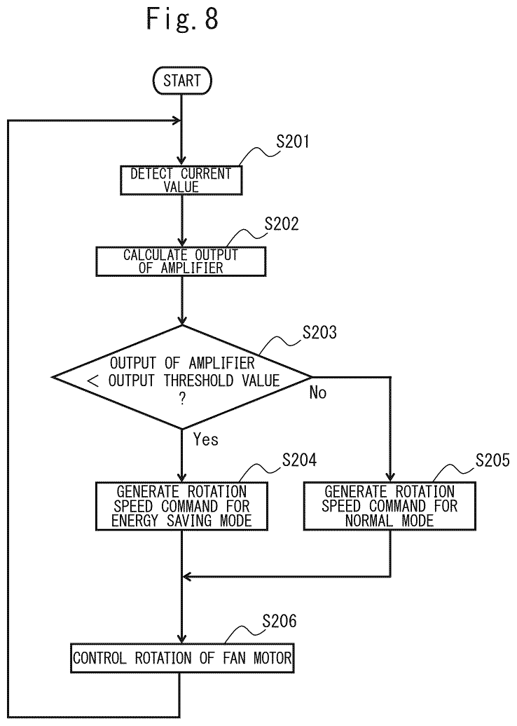

FIG. 8 is a flowchart illustrating an operation flow of rotation control of the fan motor based on the amplifier output in the motor drive device according to each embodiment of the present disclosure. FIG. 8 illustrates an example of the rotation speed command unit 11 generating discrete rotation speed commands, such as a rotation speed command for the energy saving mode and a rotation speed command for the normal mode.

In step S201, the current detection unit 14 detects the value of current flowing through the amplifier 23. Data related to the value of the current detected by the current detection unit 14 are sent to the rotation speed command unit 11 and the temperature estimation unit 15.

In step S202, the rotation speed command unit 11 calculates the output of the amplifier 23, based on the value of the current detected by the current detection unit 14.

In step S203, the rotation speed command unit 11 compares the output of the amplifier 23 with the output threshold value.

When the output of the amplifier 23 is determined to be less than the output threshold value in step S203, the rotation speed command unit 11 generates a rotation speed command for the energy saving mode in step S204. The rotation speed command for the energy saving mode generated in step S204 is sent to the fan motor control unit 12.

When the output of the amplifier 23 is determined to be equal to or greater than the output threshold value in step S203, the rotation speed command unit 11 generates a rotation speed command for the normal mode in step S205. The rotation speed command for the normal mode generated in step S205 is sent to the fan motor control unit 12.

In step S206, the fan motor control unit 12 controls rotation of the fan motor 21, based on the rotation speed command generated by the rotation speed command unit 11 and the rotation speed detection value acquired by the rotation speed detection unit 17.

It should be noted that FIG. 8 illustrates an example of the rotation speed command unit 11 generating discrete rotation speed commands, such as a rotation speed command for the energy saving mode and a rotation speed command for the normal mode. On the other hand, the output threshold value as described above is not necessary in an example of the rotation speed command unit 11 generating a rotation speed command entailing continuous change, and the fan motor control unit 12 may control rotation of the fan motor 21, based on the rotation speed command generated by the rotation speed command unit 11 and the rotation speed detection value acquired by the rotation speed detection unit 17.

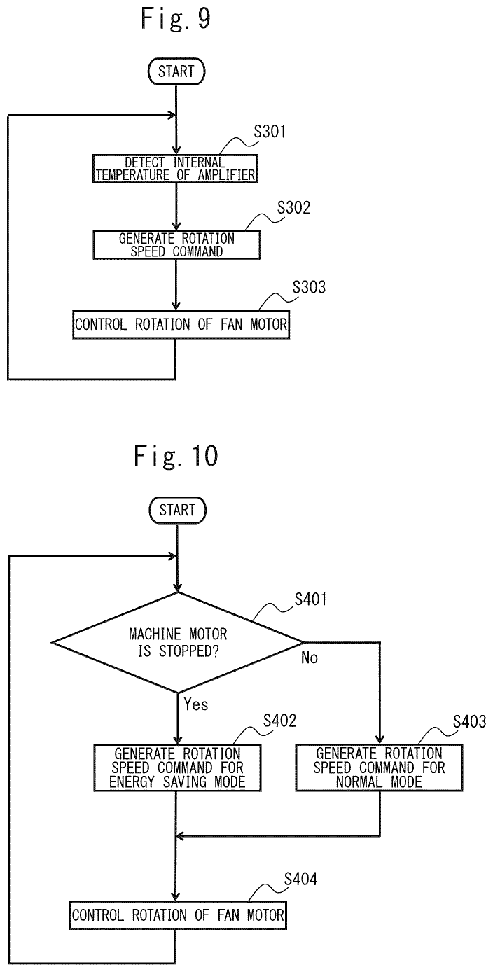

FIG. 9 is a flowchart illustrating an operation flow of rotation control of the fan motor based on the internal temperature of the amplifier in the motor drive device according to each embodiment of the present disclosure. FIG. 9 illustrates an example of the rotation speed command unit 11 generating a rotation speed command entailing continuous change, such as the rotation speed of the fan motor 21 decreasing with decrease in the internal temperature of the amplifier 23.

In step S301, the intra-amplifier temperature detection unit 18 detects the internal temperature of the amplifier 23. Data related to the internal temperature of the amplifier 23 detected by the intra-amplifier temperature detection unit 18 are sent to the rotation speed command unit 11.

In step S302, the rotation speed command unit 11 generates a rotation speed command entailing continuous change, such as the rotation speed of the fan motor 21 decreasing with decrease in the internal temperature of the amplifier 23. The rotation speed command generated in step S302 is sent to the fan motor control unit 12.

In step S303, the fan motor control unit 12 controls rotation of the fan motor 21, based on the rotation speed command generated by the rotation speed command unit 11. It should be noted that when the control of rotation of the fan motor 21 in step S303 is to be performed with higher precision, the fan motor control unit 12 may control rotation of the fan motor 21, based on the rotation speed command generated by the rotation speed command unit 11 and the rotation speed detection value detected by the rotation speed detection unit 17. In this case, acquisition of the rotation speed detection value by the rotation speed detection unit 17 is executed prior to step S303.

It should be noted that FIG. 9 illustrates an example of the rotation speed command unit 11 generating a rotation speed command entailing continuous change, such as the rotation speed of the fan motor 21 decreasing with decrease in the internal temperature of the amplifier 23. On the other hand, in an example of the rotation speed command unit 11 generating a rotation speed command for the normal mode and a rotation speed command for the energy saving mode, a mode determination may be made by using the internal temperature threshold value for distinguishing between the normal mode and the energy saving mode, based on the internal temperature of the amplifier 23.

FIG. 10 is a flowchart illustrating an operation flow of rotation control of the fan motor when the machine motor in the motor drive device according to each embodiment of the present disclosure is stopped.

In step S401, the higher level controller 2 determines whether the machine motor 22 is stopped with reference to the operation program of the machine motor 22.

When the machine motor 22 is determined to be stopped in step S401, the output of the amplifier 23 is low, and therefore, a heat-generating part is not likely to generate heat; and therefore, decreasing the rotation speed of the fan motor 21 driving the cooling fan does not cause an issue. Accordingly, in step S402, the higher level controller 2 generates a rotation speed command for the energy saving mode setting the rotation speed of the fan motor 21 to a predetermined value or less (e.g., a rotation speed zero). The rotation speed command for the energy saving mode generated in step S402 is sent to the rotation speed command unit 11.

When the machine motor 22 is not determined to be stopped in step S401, the higher level controller 2 generates a rotation speed command for the normal mode in step S403. The rotation speed command for the normal mode generated in step S403 is sent to the rotation speed command unit 11.

In step S404, the fan motor control unit 12 controls rotation of the fan motor 21, based on the rotation speed command received from the higher level controller 2 by the reception unit 20. It should be noted that when the control of rotation of the fan motor 21 in step S403 is to be performed with higher precision, the fan motor control unit 12 may control rotation of the fan motor 21, based on the rotation speed command received from the higher level controller 2 by the reception unit 20 and the rotation speed detection value detected by the rotation speed detection unit 17. In this case, acquisition of the rotation speed detection value by the rotation speed detection unit 17 is executed prior to step S404.

While the present disclosure has been described in detail above, the present disclosure is not limited to each of the aforementioned embodiments. Various additions, substitutions, changes, partial deletions, and the like may be made to the embodiments without departing from the spirit of the present disclosure or without departing from the scope of the present disclosure derived from the contents described in the claims and the equivalents thereof. Further, the embodiments may be implemented in combination. For example, the operation order or processing order is described as an example in the aforementioned embodiments and is not limited thereto. Further, the above also holds when a numerical value or a mathematical expression is used in the description of the aforementioned embodiments.

The following supplementary notes are further disclosed with regard to the aforementioned embodiments and the modified examples thereof.

### Supplementary Note 1

A motor drive device 1 including:
a rotation speed command unit 11 configured to generate a rotation speed command for a fan motor 21 driving a cooling fan for cooling a part;
a fan motor control unit 12 configured to control rotation of the fan motor 21 in accordance with the rotation speed command generated by the rotation speed command unit 11;
a storage unit 13 configured to store a set of a thermal resistance and a thermal time constant of the part related to each of a plurality of pieces of information relating to a rotation speed of the fan motor 21;
a current detection unit 14 configured to detect a value of current flowing through a part in an amplifier 23 supplying electric power to a machine motor 22; and
a temperature estimation unit 15 configured to calculate an estimated temperature of the part, based on one of a plurality of sets of the thermal resistance and the thermal time constant stored in the storage unit 13 and a value of the current detected by the current detection unit 14.

### Supplementary Note 2

The motor drive device 1 according to Supplementary Note 1, further including
an alarm output unit 16 configured to output an alarm when an estimated temperature calculated by the temperature estimation unit 15 is greater than a predetermined temperature threshold value.

### Supplementary Note 3

The motor drive device 1 according to Supplementary Note 1, further including
a rotation speed detection unit 17 configured to acquire a rotation speed detection value of the fan motor 21, wherein
the storage unit 13 stores a set of a thermal resistance and a thermal time constant of the part related to each of a plurality of rotation speed detection values of the fan motor 21, and
the temperature estimation unit calculates an estimated temperature of the part, based on a set of a thermal resistance and a thermal time constant related to the rotation speed detection value acquired by the rotation speed detection unit 17 out of a plurality of sets of the thermal resistance and the thermal time constant stored in the storage unit 13 and a value of the current detected by the current detection unit 14.

### Supplementary Note 4

The motor drive device 1 according to Supplementary Note 1, wherein
the storage unit 13 stores a set of a thermal resistance and a thermal time constant of the part related to each of a plurality of rotation speed commands for the fan motor 21, and
the temperature estimation unit 15 calculates an estimated temperature of the part, based on a set of a thermal resistance and a thermal time constant related to the rotation speed command generated by the rotation speed command unit 11 out of a plurality of sets of the thermal resistance and the thermal time constant stored in the storage unit 13 and a value of the current detected by the current detection unit 14.

### Supplementary Note 5

The motor drive device 1 according to Supplementary Note 1, wherein
the storage unit 13 stores a set of a thermal resistance and a thermal time constant of the part related to each of a plurality of rotation speed commands for the fan motor 21, and
the temperature estimation unit 15 calculates an estimated temperature of the part, based on a set of a thermal resistance and a thermal time constant related to a rotation speed command from a higher level controller operating in accordance with an operation program of the machine motor 22 out of a plurality of sets of the thermal resistance and the thermal time constant stored in the storage unit 13 and a value of the current detected by the current detection unit 14.

### Supplementary Note 6

The motor drive device 1 according to Supplementary Note 1, wherein
the rotation speed command unit 11 generates the rotation speed command, based on an output of the amplifier 23.

### Supplementary Note 7

The motor drive device 1 according to Supplementary Note 1, further including
an intra-amplifier temperature detection unit 18 configured to detect an internal temperature of the amplifier 23, wherein
the rotation speed command unit 11 generates the rotation speed command, based on the internal temperature detected by the intra-amplifier temperature detection unit 18.

### Supplementary Note 8

The motor drive device 1 according to Supplementary Note 1, wherein
the rotation speed command unit 11 generates the rotation speed command setting a rotation speed of the fan motor 21 to a predetermined value or less when the machine motor 22 is stopped.

### Supplementary Note 9

The motor drive device 1 according to Supplementary Note 1, wherein
the rotation speed command unit 11 includes a reception unit configured to receive a rotation speed command setting a rotation speed of the fan motor 21 to a predetermined value or less from a higher level controller operating in accordance with an operation program of the machine motor 22.

### Supplementary Note 10

The motor drive device 1 according to any one of Supplementary Notes 1 to 9, further including
an outside air temperature detection unit 19 configured to detect an outside air temperature outside the amplifier 23, wherein
the temperature estimation unit 15 calculates an estimated temperature of the part, based on one of a plurality of sets of the thermal resistance and the thermal time constant stored in the storage unit 13, a value of the current detected by the current detection unit 14, and the outside air temperature detected by the outside air temperature detection unit 19.

### Supplementary Note 11

The motor drive device 1 according to any one of Supplementary Notes 1 to 9, wherein
the part is a power semiconductor provided inside the amplifier 23.

### Supplementary Note 12

The motor drive device according to any one of Supplementary Notes 1 to 9, wherein
the part is a preliminary charging resistor provided inside the amplifier 23.

### REFERENCE SIGNS LIST

1 Motor drive device
11 Rotation speed command unit
12 Fan motor control unit
13 Storage unit
14 Current detection unit
15 Temperature estimation unit
16 Alarm output unit
17 Rotation speed detection unit
18 Intra-amplifier temperature detection unit
19 Outside air temperature detection unit
20 Reception unit
21 Fan motor
22 Machine motor
23 Amplifier
30 Power semiconductor
31 Semiconductor chip
32 Insulating substrate
33 Base substrate
40 Radiator

1. A motor drive device comprising:
a rotation speed command unit configured to generate a rotation speed command for a fan motor driving a cooling fan for cooling a part;
a fan motor control unit configured to control rotation of the fan motor in accordance with the rotation speed command generated by the rotation speed command unit;
a storage unit configured to store a set of a thermal resistance and a thermal time constant of the part related to each of a plurality of pieces of information relating to a rotation speed of the fan motor;
a current detection unit configured to detect a value of current flowing through a part in an amplifier supplying electric power to a machine motor; and
a temperature estimation unit configured to calculate an estimated temperature of the part, based on one of a plurality of sets of the thermal resistance and the thermal time constant stored in the storage unit and a value of the current detected by the current detection unit.

2. The motor drive device according to claim 1, further comprising an alarm output unit configured to output an alarm when an estimated temperature calculated by the temperature estimation unit is greater than a predetermined temperature threshold value.

3. The motor drive device according to claim 1, further comprising a rotation speed detection unit configured to acquire a rotation speed detection value of the fan motor, wherein
the storage unit stores a set of a thermal resistance and a thermal time constant of the part related to each of a plurality of rotation speed detection values of the fan motor, and
the temperature estimation unit calculates an estimated temperature of the part, based on a set of a thermal resistance and a thermal time constant related to the rotation speed detection value acquired by the rotation speed detection unit out of a plurality of sets of the thermal resistance and the thermal time constant stored in the storage unit and a value of the current detected by the current detection unit.

4. The motor drive device according to claim 1, wherein
the storage unit stores a set of a thermal resistance and a thermal time constant of the part related to each of a plurality of rotation speed commands for the fan motor, and
the temperature estimation unit calculates an estimated temperature of the part, based on a set of a thermal resistance and a thermal time constant related to the rotation speed command generated by the rotation speed command unit out of a plurality of sets of the thermal resistance and the thermal time constant stored in the storage unit and a value of the current detected by the current detection unit.

5. The motor drive device according to claim 1, wherein
the storage unit stores a set of a thermal resistance and a thermal time constant of the part related to each of a plurality of rotation speed commands for the fan motor, and
the temperature estimation unit calculates an estimated temperature of the part, based on a set of a thermal resistance and a thermal time constant related to a rotation speed command from a higher level controller operating in accordance with an operation program of the machine motor out of a plurality of sets of the thermal resistance and the thermal time constant stored in the storage unit and a value of the current detected by the current detection unit.

6. The motor drive device according to claim 1, wherein the rotation speed command unit generates the rotation speed command, based on an output of the amplifier.

7. The motor drive device according to claim 1, further comprising an intra-amplifier temperature detection unit configured to detect an internal temperature of the amplifier, wherein
the rotation speed command unit generates the rotation speed command, based on the internal temperature detected by the intra-amplifier temperature detection unit.

8. The motor drive device according to claim 1, wherein the rotation speed command unit generates the rotation speed command setting a rotation speed of the fan motor to a predetermined value or less when the machine motor is stopped.

9. The motor drive device according to claim 1, wherein the rotation speed command unit includes a reception unit configured to receive a rotation speed command setting a rotation speed of the fan motor to a predetermined value or less from a higher level controller operating in accordance with an operation program of the machine motor.

10. The motor drive device according to claim 1, further comprising an outside air temperature detection unit configured to detect an outside air temperature outside the amplifier, wherein
the temperature estimation unit calculates an estimated temperature of the part, based on one of a plurality of sets of the thermal resistance and the thermal time constant stored in the storage unit, a value of the current detected by the current detection unit, and the outside air temperature detected by the outside air temperature detection unit.

11. The motor drive device according to claim 1, wherein the part is a power semiconductor provided inside the amplifier.

12. The motor drive device according to claim 1, wherein the part is a preliminary charging resistor provided inside the amplifier.
